(19) United States
(12) Patent Application Publication
(10) Pub. No.: US 2013/0147832 A1
(43) Pub. Date: Jun. 13, 2013

(54) METHOD AND APPARATUS FOR REMOTE EXTENSION DISPLAY

(71) Applicant: Navin Patel, Brampton (CA)

(72) Inventor: Navin Patel, Brampton (CA)

(73) Assignee: ATI TECHNOLOGIES ULC, Markham (CA)

(21) Appl. No.: 13/313,286

(22) Filed: Dec. 7, 2011

(51) Int. Cl. G09G 5/00

(52) U.S. Cl. 345/619

(57) ABSTRACT

A method and apparatus for extending the display area of a source device (SD) to one or more target devices (TDs), are described. According to a method, information that may be displayed at the SD is transmitted to the one or more TDs. At the TDs, the information is displayed and manipulated by a user. An indication of the user's manipulations of the information is received at the SD where the information is physically updated. The SD transmits the updated information to the one or more TDs in order to synchronize the information displayed by the one or more TDs with the transmitted information.

### FIELD OF INVENTION

The present invention is generally directed to image processing and, more particularly, to extending a device display.

### BACKGROUND

A user of a computing device that includes a display feature, for example, a personal computer (PC) that is associated with a single monitor, may desire to extend the display area of the single monitor onto multiple monitors, which may also be associated with the computing device. As a result, this stretching of the display area may allow the user to view a plurality of relevant image data at the same time using multiple monitors and a single computing device. However, each of the monitors used is restricted to the capability of the computing and its graphics configuration.

### SUMMARY OF EMBODIMENTS

A method and apparatus for extending the display area of a source device (SD) to one or more target devices (TDs). Information that may be displayed at the SD is transmitted to the one or more TDs. At the TDs, the information is displayed and manipulated by a user. An indication of the user's manipulations of the information is received at the SD where the information is updated. The SD transmits the updated information to the one or more TDs in order to synchronize the information displayed by the one or more TDs with the transmitted information.

### BRIEF DESCRIPTION OF THE DRAWINGS

A more detailed understanding may be had from the following description, given by way of example in conjunction with the accompanying drawings wherein:

FIG. 1A is a block diagram of an example device in which one or more disclosed embodiments may be implemented;

FIG. 1B is a block diagram of an alternate example device in which one or more disclosed embodiments may be implemented;

FIG. 2 is a block diagram of communications between source and target devices each including a driver;

FIG. 3 is a block diagram of communications between source and target devices including both drivers and hot zones;

FIG. 4 is a flow diagram of configuration of the source and target devices' drivers and hot zones;

FIG. 5 is a block diagram of synchronization of information between source and target devices; and

FIG. 6 is a flow diagram of synchronization of information between source and target devices.

### DETAILED DESCRIPTION OF THE EMBODIMENTS

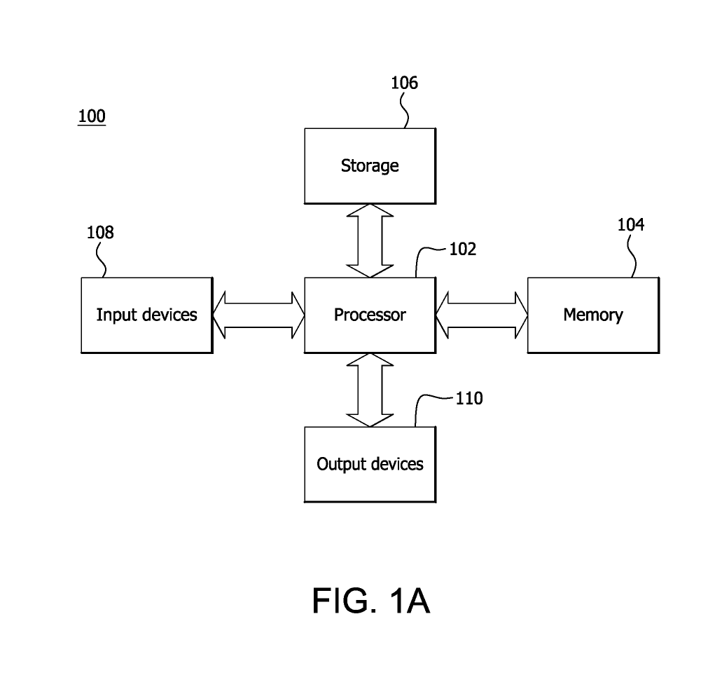

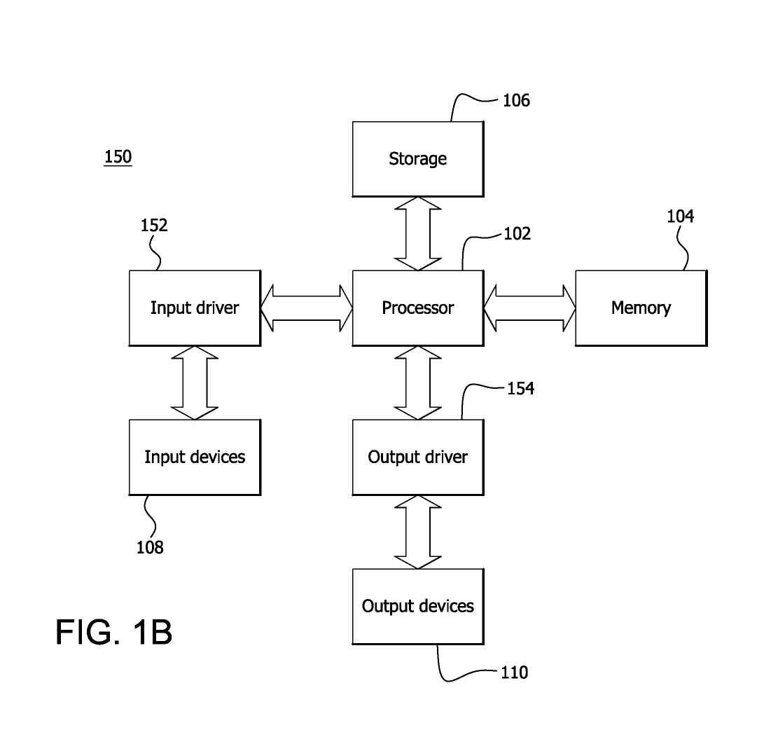

FIG. 1A is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. It is understood that the device 100 may include additional components not shown in FIG. 1A.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

FIG. 1B is a block diagram of an alternate example device 150 in which one or more disclosed embodiments may be implemented. Elements of the device 150 which are the same as in the device 100 are given like reference numbers. In addition to the processor 102, the memory 104, the storage 106, the input devices 108, and the output devices 110, the device 150 also includes an input driver 152 and an output driver 154.

The input driver 152 communicates with the processor 102 and the input devices 108, and permits the processor 102 to receive input from the input devices 108. The output driver 154 communicates with the processor 102 and the output devices 110, and permits the processor 102 to send output to the output devices 110.

A device may be associated with one or many display features. For example, a personal computer may have one or more monitors associated with it for display of information. The association of more than one display feature (e.g., monitors) with the device (e.g., PC) may enable a plurality of relevant image data (e.g., multiple windows) to be displayed at one time.

For example, the monitors associated with the PC may receive information from the PC's graphics card in order to display multiple windows. The monitor, however, is restricted by the PC's configurations and capabilities for the display of the multiple windows. In order to overcome this display restriction, a remote connection device (RCD) may be installed on the PC in order to extend the display capability of the PC.

The RCD enables communications between one or more PCs, that have installed the RCD, for the transmission and display of relevant image data. The RCD may be, but is not limited to, a device driver that communicates with the PC's graphics board and memory in order to extract and format relevant image data for transfer to another PC where the relevant image data may be displayed in order for a user to manipulate.

The RCD may also be used to configure specialized input devices without the restrictions of the PC's configurations and capabilities, such as a virtual mouse which may be used by one or more PC's.

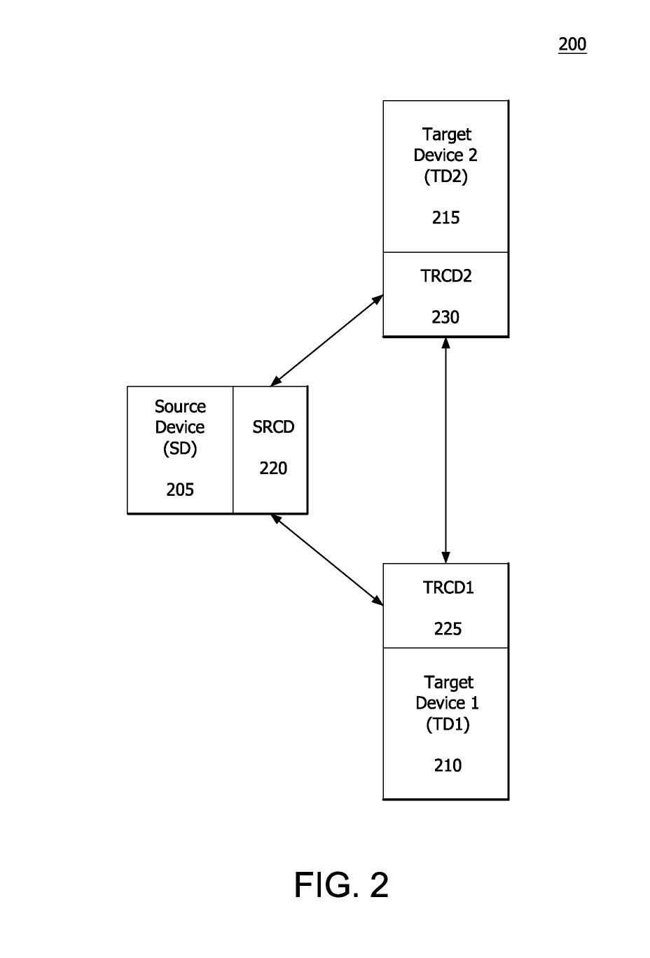

FIG. 2 is a high level block diagram 200 of communications between one or more source devices (SD) and target devices (TDs), each device includes a RCD. The SD 205, TD1 210 and TD2 215, may be any type of wireless or wired devices that is configured to display information, including but not limited to a PC, a smartphone, a tablet computer, a set top box, a television or a game console.

The SD 205, TD1 210 and TD2 215 may be configured to include a RCD, source RCD (SRCD) 220, target RCD (TRCD), TRCD1 225 and TRCD2 230, respectively. The RCDs may be used to provide connectivity between the SD 205, TD1 210 and TD2 215. The RCDs may be used to determine the types of communication protocols and communications media that may be used between the SD 205, TD1 210 and TD2 215. The types of communication protocols may include but are not limited to wireless local area network (WLAN), transmission control/internet protocol (TCP/IP), user datagram protocol (UDP), file transfer protocol (FTP), hyper text transfer protocol (HTTP), post office protocol 3 (POP3) and various radio transmissions such as but not limited to Blue Tooth, frequency shift keying (FSK), amplitude shift keying (ASK) and phase shift keying (PSK).

The SRCD 220 may be used to configure a connection using a communication protocol between the SD 205, TD1 210 and TD2 215. Information regarding the connection may be relayed to the TRCD1 225 and TRCD2 230. Once the connection between the SD 205, TD1 210 and TD2 215 is established, the RCDs for each device may be used to determine whether the device is in on or off mode and whether the device is in awake or sleep mode. The RCDs may also be used to determine whether the devices are in proximity to one another or whether one or more may be in a remote location. In addition, the RCDs may be used to compress, decompress and transmit information in a plurality of media formats.

Referring back to FIG. 2, SD 205, TD1 210 and TD2 215 are depicted. Each device may be configured with its own specific display coordinates and layout. The SD 205, TD1 210 and TD2 215 may be configured to each include a RCD, SRCD 220, TRCD1 225 and TRCD2 230, respectively. The RCDs may allow for short range high bandwidth communication transfer between devices. The communications may occur via any communication protocol determined by the SRCD 220. The communications media that may be exchanged between the SD 205, TD 210 and TD2 215 may include but are not limited to: data, graphics, video and sound.

Any one of the devices configured with a RCD may be configured as the SD 205. The SD 205 is any device that initiates the exchange of relevant image data. Only one SD 205 may be configured at one time, while one or more TDs may be configured at one time. Any TD may be reconfigured as a SD 205, and the SD 205 may be reconfigured as a new TD. For example, TD1 210, may be reconfigured as the SD 205, while the SD 205 may be reconfigured as TDX. On a condition that TD1 210 is reconfigured as SD 205, all of the relevant information associated with SD 205 is transferred to TD1 210, which is now the reconfigured SD 205.

The SD's 205 display area coordinates are configured as the base coordinates for the relevant image data. Once the SD 205 is determined, the other devices in communication with the SD 205 are determined as TDs, TD1 210 and TD2 215, and their respective base coordinates for relevant image data are also determined. The base coordinates for TD1 210 and TD2 215 may be communicated to the SD 205 via TRCD1 225 and TRCD2 230, and the SRCD 220. Also, the base coordinates for the SD 205 may be communicated to TD1 210 and TD2 215 via the SRCD 220 and TRCD1 225 or TRCD2 230, respectively.

The SD 205 may be located in a particular location and TD1 210 and/or TD2 215 may be located in a remote location, or in a location proximate to the SD 205. The SD 205 via the SRCD 220 may establish a connection with TD1 210 via TRCD1 225 and TD2 215 via TRCD2 230. The communication may be established in order for the SD 205 to extend its display area for relevant image data.

At any point in the method of FIG. 2, additional actions may be performed between SD 205, TD1 210, TD2 215, SRCD 220, TRCD1 225 and TRCD2 230.

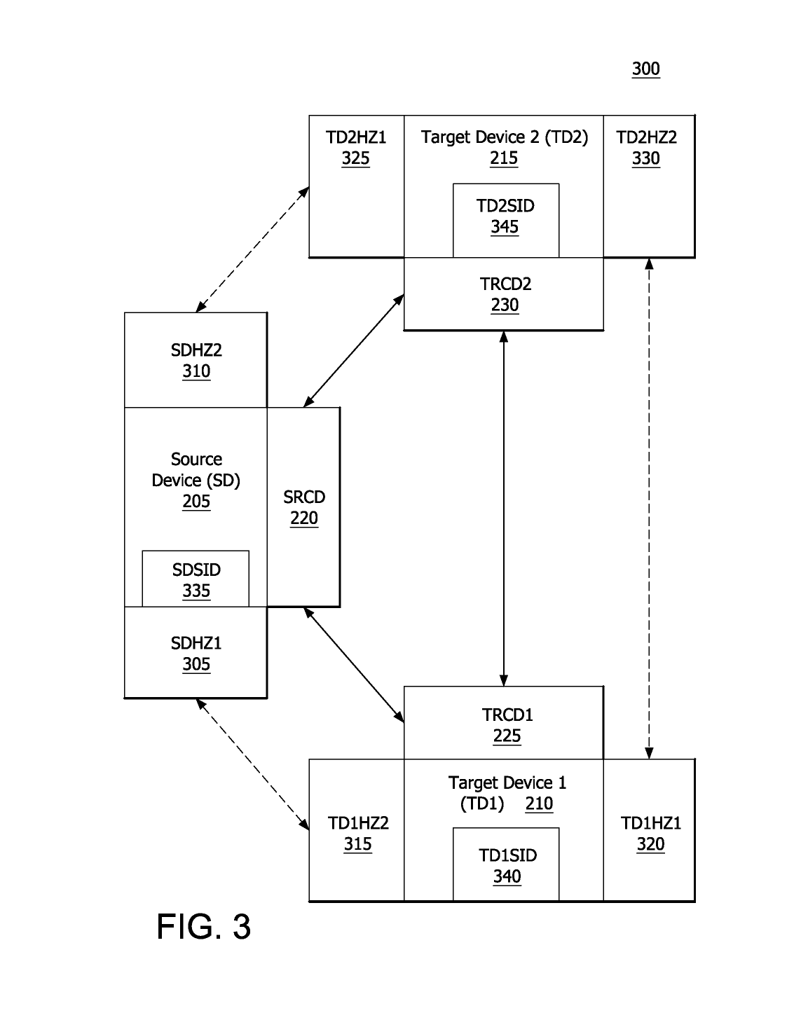

FIG. 3 is a detailed block diagram 300 of communications between SD 205, TD1 210 and TD2 215 each configured to include a RCD and one or more hot zones (HZs). The coordinates for each device's display area may be extended in various directions. For example, the coordinates for the display area may be extended up, down, left or right. A HZ may be an extension of a device's display area. A device may have one or a plurality of HZs it may use to establish the additional display area for relevant image data. The additional display area may be located on the TD1 210 or TD2 215. In order for the SD 205 to use the additional display area of the TD1 210 or TD2 215, a HZ of the SD 205, SDHZ1 305, SDHZ2 310, may be mapped to a HZ of one or more TDs (TDHZ).

The SRCD 220 is configured to map the SDHZ1 305 to TD1 HZ2 315, and SDHZ2 310 to TD2 HZ1 325. The SRCD 220 is also configured to map TD1 HZ1 320 to TD2 HZ2 330. The SRCD 220 is configured to include all possible configurations for TDHZs for which it is associated.

In order for the SRCD 220 to map the HZs certain information is needed from the TRCD1 225 and TRCD2 230. TRCD1 225 and TRCD2 230 are configured with information regarding the coordinates of their respective device's display area, the graphic information associated with the device's display area and the HZs associated with the device's display area. This information is communicated to the SRCD 220 by TRCD1 225 and TRCD2 230. The SRCD 220 may provide similar information regarding the SD 205 to TD1 210 and TD2 215 via TRCD1 225 and TRCD2 230.

Each TRCD, for example, TRCD1 225 and TRCD2 230, is capable of identifying and configuring a new TD. Once the new TD is identified and configured, the SRCD 220 may be updated with the new TD's configurations by the TRCD, TRCD1 225 and TRCD2 230, that configured the new TD.

Once the HZs of the SD 205, TD1 210 and TD2 215 are mapped, connections between the HZs may be established. The connections between the HZs provide the ability for relevant image data to be transferred and displayed on one or more devices. A SDs specialized input device (SSID) 335 (e.g., a mouse) may be used to move the relevant image data (e.g., a window) from the SDHZ1 305 to TD1 HZ2 315 or SDHZ2 310 to TD2 HZ1 325, enabling a TD's display area to display the relevant image data. For example, a window on a SD 205 may become displayed on TD1 210 by using a mouse, SSID 335, to drag the window into the SDHZ1 305, which is mapped to the TD1HZ2 315. Once the window is within the coordinates of the SDHZ1 305, the TD1HZ2 315 is aware of the window, and the TD1s 210 display area is capable of displaying the window in its display area. The window is displayed using the coordinates and graphic configurations of the TD1 210.

Referring back to FIG. 3, the SD 205 includes a SRCD 220 and one or more hot zones, SDHZ1 305 and SDHZ2 310. The TD1 210 also includes a TRCD1 225 and one or more hot zones TD1HZ1 320 and TD1HZ2 315. In addition, the TD2 215 includes a TRCD2 230 and one or more hot zones TD2HZ1 325 and TD2HZ2 330. While only two hot zones per device are depicted in FIG. 3 each device may have one or a plurality of hot zones.

The SRCD 220 is in communication with TRCD1 225 and TRCD2 230. The display area coordinate information, graphic information and HZ information of TD1 210 and TD2 215 are provided to the SD 205 using SRCD 220, TRCD1 225 and TRCD2 230. In addition, similar information may be provided regarding the SD 205 to TD1 210 and TD2 215 using SRCD 220, TRCD1 225 and TRCD2 230.

Relevant image data may be displayed in the display area of the SD 205. The SD 205 may determine to move the relevant image data to TD1 210. The SDSID 335 may be used to move the relevant image data into the SDHZ1 305, which may be mapped to TD1HZ2 315. The relevant image data may be displayed using the display feature of TD1 210. The SDSID 335 may be available for use by TD1 210, in addition to TD1's 210 specialized input devices (TD1SID) 340. TD1 210 may determine to manipulate the relevant image data or may determine to move the relevant image data to TD2 215 or back to the SD 205.

If TD1 210 determines to manipulate the relevant image data in its display area, either the SDSID 335 or the TD1SID 340 may be used. Even though the relevant image data is manipulated via the display of TD1 210 using either SDSID 335 or TD1SID 340, the relevant image data is updated at the SD 205. As changes are made via TD1's 210 display area to the relevant image data, the relevant image data is updated at the SD 205. The relevant image data including the changes is relayed to the display area of TD1 210 using SRCD 220 and TRCD1 225, and subsequently refreshed at specific intervals by the SD 205.

For example, if a window (i.e., relevant image data) is displayed in the display area of the SD 205 and the SD 205 determines to move the window to TD1 210, the SD's mouse (i.e., SDSID) 335 may be used to move the window into SD's HZ, SDHZ1 305, which is mapped to TD1's HZ, TD1HZ2 315. The window may now be displayed in the display area of TD1 210. TD1 210 may use the SDSID 335 used to move the window, or any its own TD1SID's 340 to manipulate the window. TD1 210 may use any TD1SID's 340 available to it including but not limited to: a keyboard, mouse, radio frequency device or extender device, which may be either wired or wireless to manipulate the window.

Changes to the window are realized at the SD 205 and relayed to the TD1's 210 display area. Since the window initiated at the SD 205, the window is associated with the SD 205 and is merely displayed by the TD1 210. The TD1 210 displays changes to the window that are relayed by the SD 205. No changes to the window are made at the TD1 210.

However, if relevant image data is a file transfer, for example, and is physically moved from the SD 205 to the TD1 210, the relevant image data is fully transferred to the TD1 210 and does not require the SD 205 to realize and relay changes to the physically moved relevant image data.

If TD1 210 determines to move the relevant image data to TD2 215, TD2 215 may use the TD1SID 340 or its own TD2SID 345 to manipulate the relevant image data. Even though the relevant image data is manipulated via the display of TD2 215 and using either TD1SID 340 or TD2SID's 345, the relevant image data is updated at the SD 205. As changes are made via TD2's 215 display area to the relevant image data, the relevant image data is updated at the SD 205. The relevant image data including any changes is relayed to the display area of TD2 215 and subsequently refreshed at specific intervals by the SD 205.

For example, a window (i.e., relevant image data) may originate in the display area of the SD 205 and be moved to TD1 210. TD1 210 determines to move the window to TD2 215. TD1's mouse (i.e., TD1SID) 340 may be used to move the window into the TD1's HZ, TD1HZ1 320, which is mapped to TD2's HZ, TD2HZ2 330. The window may now be displayed in the display area of TD2 215. TD2 215 may use the TD1SID 340, used to move the window, or any of its TD2SID's 345 to manipulate the window.

Changes to the window are realized at the SD 205 and relayed to the TD2's 215 display area. Since the window initiated at the SD 205, the window is associated with the SD 205 and is merely displayed by the TD2 215. The TD2 215 displays changes to the window that are relayed by the SD 205. No changes to the window are made at the TD2 215. TD2 215 may determine to move the data to the SD 205 or to TD1 210.

At any point in the method of FIG. 3, additional actions may be performed between SD 205, SRCD 220, SDHZ1 305, SDHZ2 310, TD1 210, TRCD1 225, TD1HZ1 320, TD1HZ2 315, TD2 215, TRCD2 230, TD2HZ1 325, TD2HZ2 330, SDSID 335, TD1SID 340 and TD2SID 345.

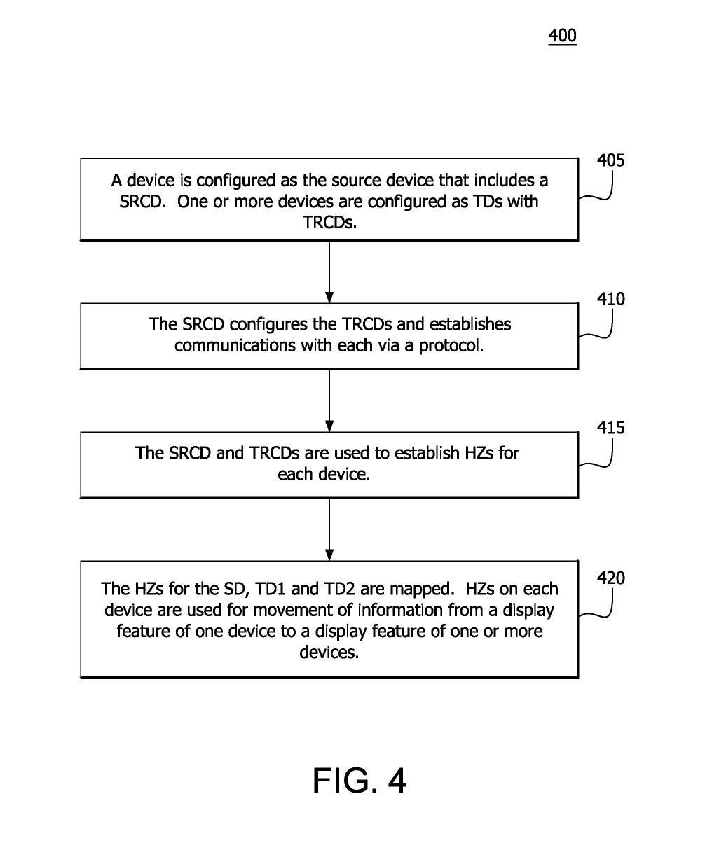

FIG. 4 is a flow diagram 400 of configuration of the SD 205, TD1 210 and TD2 215 RCDs and HZs. A device is configured 405 as a SD 205 that includes a SRCD 220 and one or more HZs, SDHZ1 305 and SDHZ2 310. Devices that are not SDs are configured 405 as TDs. There may be one or more TDs, TD1 210 and TD2 215. TD1 210 may include a TRCD1 225 and one or more HZs, TD1HZ1 320 and TD2HZ2 315. TD2 215 may include TRCD2 230 and one or more HZs, TD2HZ1 325 and TD2HZ2 330. The RCDs of each device are configured by the SD 205, which establishes communications with each of the TDs via a protocol, which may be TCP/IP 410. The SRCD 220, TRCD1 225 and TRCD2 230 are used to establish HZs on each of the devices 415.

The SRCD 220 communicates with TRCD1 225 and TRCD2 230 to map the HZs 420 of the SD 205 to TD1 210 and TD2 215. The SRCD 220 also maps the HZs 420 of the TD1 210 to TD2 215. The HZs on each device are used for movement of information from a display feature of one device to a display feature of one or more devices 420.

At any point in the method of FIG. 4, additional actions may be performed. The flow of FIG. 4 may be configured in any order and is not limited to the depiction in FIG. 4.

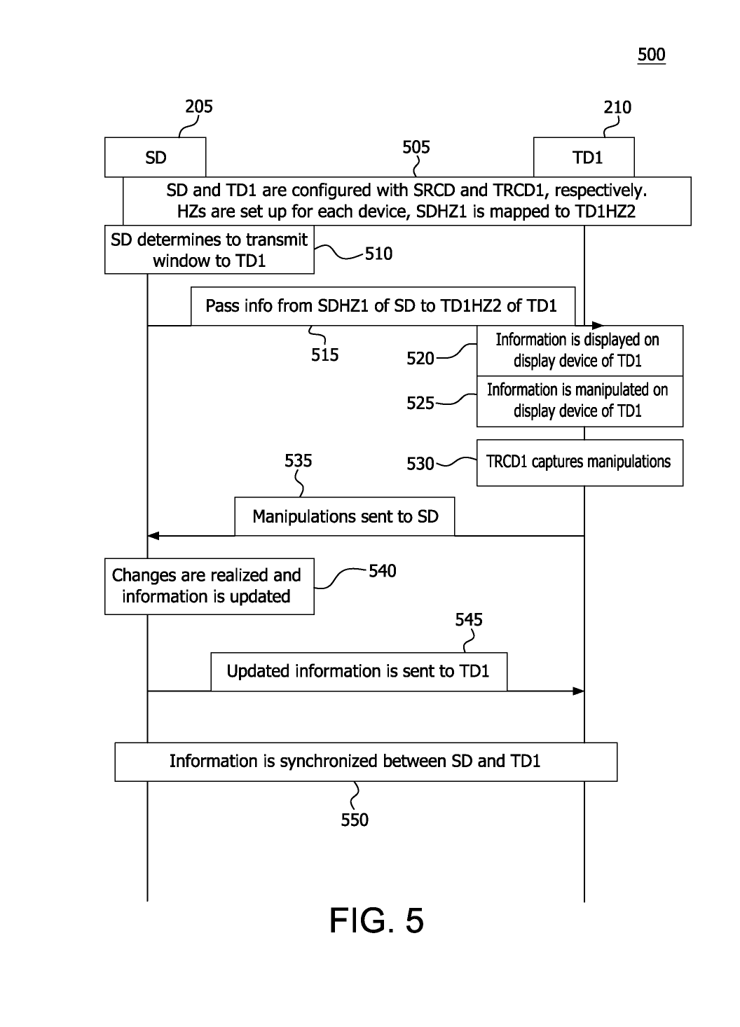

FIG. 5 is a block diagram 500 of synchronization of information between a SD 205 and a TD1 210. While only one TD, TD1 210, is depicted in FIG. 5, a plurality of TDs may be used. The SD 205 and the TD1 210 are configured 505 to each include a RCD, SRCD 220 and TRCD1 225. The SRCD 220 and TRCD1 225 are used to establish communications between the SD 205 and the TD1 210. HZs are configured 505 for the SD 205 and the TD1 210 and mapped between the two devices via SRCD 220 and TRCD1 225.

The SD 205 may display relevant image data within a display area of the SD 205. For example, the SD 205 may be a PC and the display area may be a monitor associated with the PC. The relevant image data may be a window, which is displayed by the monitor. The SD 205 may determine to transmit the window 510 to another device, the TD1 210. The window is passed 515 from the SDHZ1 305 of the SD 205 to the TD1HZ2 315 of the TD1 210. The window may be moved using any specialized input device (SID) of the SD 205, such as a mouse. The SDSID 335 of the SD 205 used to move the window may be displayed in the display area of TD 210 as a virtual input once the window is moved.

Movement of the window from the SDHZ1 305 to the TD1HZ2 315 enables the window to be displayed 520 via the display area of the TD1 210. For example, the window that was once displayed on the SD 205 monitor is now displayed on the TD1 210 screen, whereby the TD1 210 may be an I-Pad and the TD1 210 screen may be the user interface (UI) screen of the I-Pad.

Once the window is displayed 520 on the TD1 210 display area, the TD1SIDs 340 of the TD1 210 and the SDSID 335 may be used to manipulate 525 the window on the TD 210 display. While the window on the TD1 210 display shows the changes made using the TD1SIDs 340 and SDSID 335, the changes are made at the SD 205.

The TRCD1 225 captures the manipulations 530 made on the TD1 210 display area and transmits the changes 535 to the SRCD 220. The SRCD 220 makes the actual changes to the window 540, realizes the edits 540 and relays the changes 545 to the TRCD1 225, which then displays the changes on the TD1 210 display. This exchange and relay of information enables synchronization 550 between the SD 205 and TD1 210.

At any point in the method of FIG. 5, additional actions may be performed between the SD 205 and TD1 210. Additional TDs, not included in FIG. 5, may receive the window from either the SD 205 or TD1 210 and may be used to manipulate the window.

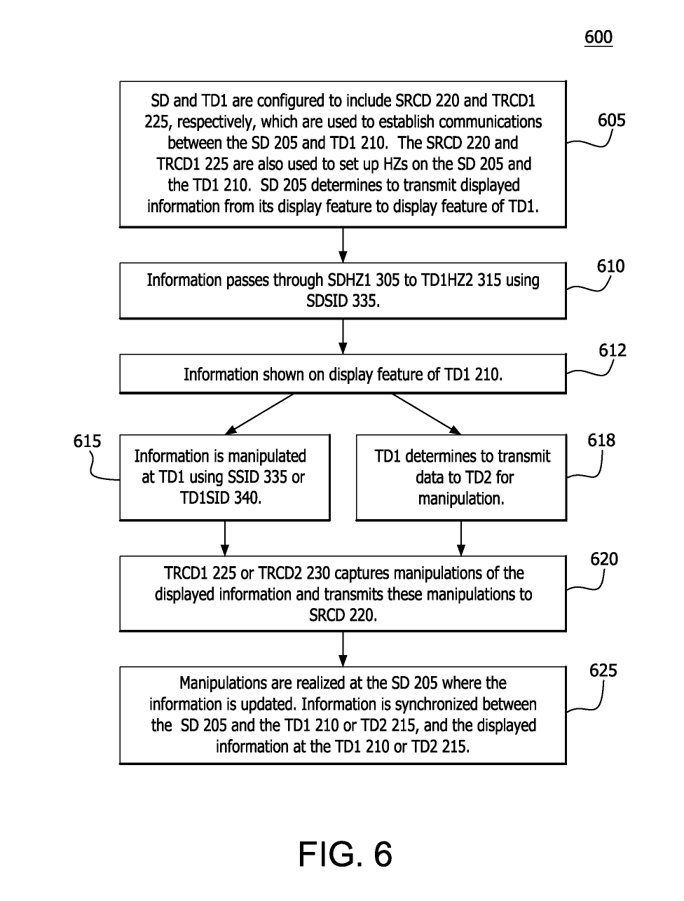

FIG. 6 is a flow diagram 600 of synchronization of information between SD 205 and TD1 210. The SD 205 and TD1 210 are configured 605 to include SRCD 220 and TRCD1 225, respectively, which are used to establish communications 605 between the SD 205 and TD1 210. The SRCD 220 and TRCD1 225 are also used to set up HZs on the SD 205 and the TD1 210. Once the HZs on each device are determined, displayed information may be exchanged 605 between SD 205 and TD1 210. Information passes through 610 the HZ of the SD 205, SDHZ1 305 to the HZ of the TD1 210, TD1HZ2 315 using the SDSID 335. The SDSID 335 is available to the TD1 210 as a virtual input. The TD1 210 may use the SDSID 335 or any of its own TD1SIDs 340 in order to manipulate the information in its display area.

The information is displayed in the display area 612 of the TD1 210. The TD1 210 may choose to manipulate the data 615 or may choose to transmit the information to a TD2 215 for manipulation 618. If the TD1 210 chooses to manipulate the data 615, the TD1 210 may use the SDSID 335 or any of the TD1SIDs 340. The TRCD1 225 captures the manipulations 620 of the displayed information and transmits the manipulations the SRCD 220. The SRCD 220 makes the actual changes 625 to the information, realizes the edits and relays the changes to the TRCD1 225, which then displays the changes on the TD1 210 display. This exchange and relay of information enables synchronization between the SD 205 and TD1 210.

If the TD1 210 chooses to transmit the information 618 to the TD2 215, the information passes through the HZ of the TD1 210, TD1HZ1 320 to the HZ of the TD2 215, TD2HZ2 330. The TD2 215 may use the TD1SID 340, that is passed from the TD1 210, or any of the TD2SIDs 345 to manipulate the data. The TRCD2 230 captures the manipulations of the displayed information 620 and transmits the manipulations to SRCD 220. The SRCD 220 makes the actual changes 625 to the information, realizes the edits and relays the changes to the TRCD2 230, which then displays the changes on the TD2 215 display. This exchange and relay of information enables synchronization between the SD 205 and TD2 215.

The TD2 215 may chose to transmit the information back to the TD1 210 or directly to the SD 205 via the HZs of each. By moving the information into the HZs, the display of information will appear either on the display of the SD 205 or the display of the TD1 210, depending on which HZ is chosen, TD2HZ1 325 or TD2HZ2 330, respectively.

At any point in the method of FIG. 6, additional actions may be performed between the SD 205, TD1 210 and TD2 215. Additional TDs not included in FIG. 6 may receive the information from either the SD 205, TD1 210 or TD2 215.

In an embodiment, the SD 205 may display each of its HZs, SDHZ1 305 and SDHZ2 310. By moving the SDSID 335 into one of the HZs, which are mapped to the HZ of TD1 210 and TD2 215, the SD 205 may display the display area of either TD1 210 or TD2 215. For example, the SDSID 335 may be moved into SDHZ1 305, which is mapped to TD1HZ2 315. The movement of the mouse into SDHZ1 305 may allow for the display area of TD1 210 to move into the display area of the SD 205. This may be useful when TD1 210 is in a different geographic location than the SD 205 and the ability to view the display of TD1 210 is required.

In an embodiment, a SD 205 may be configured to establish a connection with an extender. Any form of communication device in association with a connecting device (i.e., either SD or TD), for which a RCD may be installed, is considered an extender. Any device with miss-matching communications protocol that requires a customized hardware device to translate one communications protocol to another may use an extender. If a RCD cannot be installed, a custom build extender may be used and may act as a protocol translator and may also contain a suitable processor that functions as the SRCD or TRCD, depending on the device.

An extender may establish a wired or wireless connection with the SD 205. The extender may be used to communicate with devices that are unable to establish a connection with the SD 205. The extender may be responsible for hardware acceleration and compression, connectivity and manipulation. For example, an extender may be input into the universal serial bus (USB) of a SD 205, which may be a PC, to enable communication between the PC and a projector that is unable to communicate directly with the PC. An extender may be used by one or more devices, (e.g., the projector) while having a direct connection to the SD 205 (e.g., PC).

In an embodiment, both the SD 205 and TD1 210 have the same hardware that supports a communication protocol, for example, TCP/IP. The extender is considered built into the communication protocol. For example, TCP/IP to TCP/IP communication, Bluetooth to Bluetooth communication or USB to USB communication.

In another embodiment two different communication protocols may be used. For example SD 205 uses TCP/IP and TD1 210 uses USB. An extender device is used so that SD 205 may communicate with TD1 210 by translating information from a TCP/IP communications protocol to a USB based protocol.

In a further embodiment, SD 205 uses a TCP/IP protocol and TD1 210 uses a video graphics array (VGA). The extender may be an input of TCP/IP and an output of VGA. The video data contained within the TCP/IP protocol may be translated to VGA for TD1 210. In addition, HZ and other relevant information may be processed internally by a processor in the extender device.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor.

Suitable processors include, by way of example, a general purpose processor, a special purpose processor, a conventional processor, a digital signal processor (DSP), a plurality of processors, one or more processors in association with a DSP core, a controller, a microcontroller, Application Specific Integrated Circuits (ASICs), Field Programmable Gate Arrays (FPGAs) circuits, any other type of integrated circuit (IC), and/or a state machine.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture and test semiconductor devices (e.g., processors) that embody various aspects of the present invention.

What is claimed is:

1. A method for extending a display area of a source device (SD) to one or more target devices (TDs), the method comprising:
displaying information at the SD;
transmitting the information to the one or more TDs, wherein the information is displayed and manipulated;
receiving at the SD an indication of the manipulations at the one or more TDs;
updating the information based on the indication of manipulations; and
transmitting updated information to the one or more TDs in order to synchronize the information displayed by the one or more TDs with the updated information.

2. The method of claim 1 wherein the SD and the one or more TDs include one or more hot zones (HZs).

3. The method of claim 2, wherein the information is transmitted through the one or more HZs.

4. The method of claim 1, wherein the manipulations are captured via one or more remote connection devices (RCDs).

5. The method of claim 4, wherein the RDCs are associated with the SD and the one or more TDs.

6. The method of claim 4, wherein the RCDs are configured by the SD.

7. The method of claim 4, wherein the RCDs are used to map hot zones (HZs) of the SD to the HZs of the one or more TDs.

8. The method of claim 1, wherein the transmitting occurs via transmission control protocol/internet protocol (TCP/IP).

9. The method of claim 1, wherein the SD and the one or more TDs are associated using one or more specialized input devices (SIDs), wherein the SIDs provide protocol mapping.

10. A source device (SD), comprising:
a display configured to display information;
a transmitter configured to transmit the information to one or more target devices (TDs) for display and manipulation;
a receiver configured to receive an indication of manipulations at the one or more TDs;
a processor configured to update the information based on the indication of manipulations; and
the transmitter further configured to transmit updated information to the one or more TDs in order to synchronize the information displayed by the one or more TDs with the updated information.

11. The SD of claim 10, wherein the SD and the one or more TDs include one or more hot zones (HZs).

12. The SD of claim 11, wherein the information is transmitted through the one or more HZs.

13. The SD of claim 10, wherein the manipulations are captured via one or more remote connection devices (RCDs).

14. The SD of claim 13, wherein the RDCs are associated with the SD and the one or more TDs.

15. The SD of claim 13, wherein the RCDs are configured by the SD.

16. The SD of claim 13, wherein the RCDs are used to map hot zones (HZs) of the SD to the HZs of the one or more TDs.

17. The SD of claim 10, wherein the transmitting occurs via transmission control protocol/internet protocol (TCP/IP).

18. The SD of claim 10, wherein the SD and the one or more TDs are associated using one or more specialized input devices (SIDs), wherein the SIDs provide protocol mapping.

19. A computer-readable storage medium storing a set of instructions for execution by a general purpose computer to extending a display area of a source device (SD) to one or more target devices (TDs), the set of instructions comprising:
displaying information at the SD;
transmitting the information to the one or more TDs, wherein the information is displayed and manipulated;
receiving at the SD an indication of the manipulations at the one or more TDs;
updating the information based on the indication of manipulations; and
transmitting updated information to the one or more TDs in order to synchronize the information displayed by the one or more TDs with the updated information.
